(19) United States
(12) Patent Application Publication
(10) Pub. No.: US 2025/0062547 A1
(43) Pub. Date: Feb. 20, 2025

(54) MIMO (MULTIPLE INPUT AND MULTIPLE OUTPUT) ANTENNA

(71) Applicant: MEDIATEK INC., Hsin-Chu (TW)

(72) Inventor: Chung-Hsin Chiang, Hsinchu City (TW)

(73) Assignee: MEDIATEK INC., Hsin-Chu (TW)

(21) Appl. No.: 18/797,492

(22) Filed: Aug. 7, 2024

Related U.S. Application Data
(60) Provisional application No. 63/520,378, filed on Aug. 18, 2023.

(51) Int. Cl. H01Q 21/26; H01Q 21/06

(52) U.S. Cl. CPC H01Q 21/26; H01Q 21/062

(57) ABSTRACT

An antenna includes M radiators and M feeding elements. The M radiators can be used to wirelessly access a set of first signals. The M feeding elements can be formed below the M radiators, connected to a processing circuit, and used to access a set of second signals corresponding to the set of first signals between the M feeding elements and the processing circuit. M can be a positive integer larger than 3.

### CROSS REFERENCE TO RELATED APPLICATIONS

This application claims the benefit of U.S. Provisional Application No. 63/520,378, filed on Aug. 18, 2023. The content of the application is incorporated herein by reference.

### BACKGROUND

With the increasing prevalence of portable devices, the integration of antennas within such devices has become widespread. Presently, a variety of antennas are available for implementation. However, existing antenna devices are significantly constrained in terms of radiation directionality, frequently supporting only a single radiation direction. Moreover, the performance metrics of these antennas, such as cumulative distribution function (CDF), require enhancement. Additionally, there is a pressing need to reduce the physical dimensions of the antennas. Currently, there is an absence of adequate solutions to address the aforementioned challenges.

### SUMMARY

An embodiment provides an antenna including M radiators and M feeding elements. The M radiators can be used to wirelessly access a set of first signals. The M feeding elements can be formed below the M radiators, connected to a processing circuit, and used to access a set of second signals corresponding to the set of first signals between the M feeding elements and the processing circuit. M can be a positive integer larger than 3.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an oblique view of an antenna according to an embodiment.

FIG. 2 illustrates a side view of the antenna of FIG. 1.

FIG. 3 illustrates the antenna of FIG. 1 connected to a processing circuit.

FIG. 4 illustrates a part of the antenna of FIG. 1 according to embodiments.

FIG. 5 illustrates a part of the antenna of FIG. 1 according to embodiments.

FIG. 6 illustrates a part of an antenna connected to a processing circuit according to an embodiment.

FIG. 7 illustrates an antenna according to another embodiment.

FIG. 8 illustrates a part of an antenna according to another embodiment.

FIG. 9 illustrates an antenna according to another embodiment.

FIG. 10 illustrates an antenna according to another embodiment.

FIG. 11 illustrates an antenna according to another embodiment.

FIG. 12 illustrates an antenna according to another embodiment.

FIG. 13 illustrates an antenna according to another embodiment.

FIG. 14 illustrates an antenna according to another embodiment.

### DETAILED DESCRIPTION

In the text, when it mentions ‘A is coupled to B,’ it can refer to either physical coupling through physical contact or wireless coupling through an electromagnetic field. When it mentions ‘A is connected to B,’ it refers to a physical connection.

In the text, when it is mentioned that ‘X is formed below Y,’ it means that X can be in a relatively lower position than Y, where X is partially or entirely within a projection area of Y, or X may not overlap with the projection area of Y.

In the text, when it is mentioned that “X is formed directly beneath Y”, it means that Xis in a lower position relative to Y, and X is partially or entirely within the projection area of Y.

In this text, when it mentions accessing a signal, it refers to transmitting and/or receiving that signal.

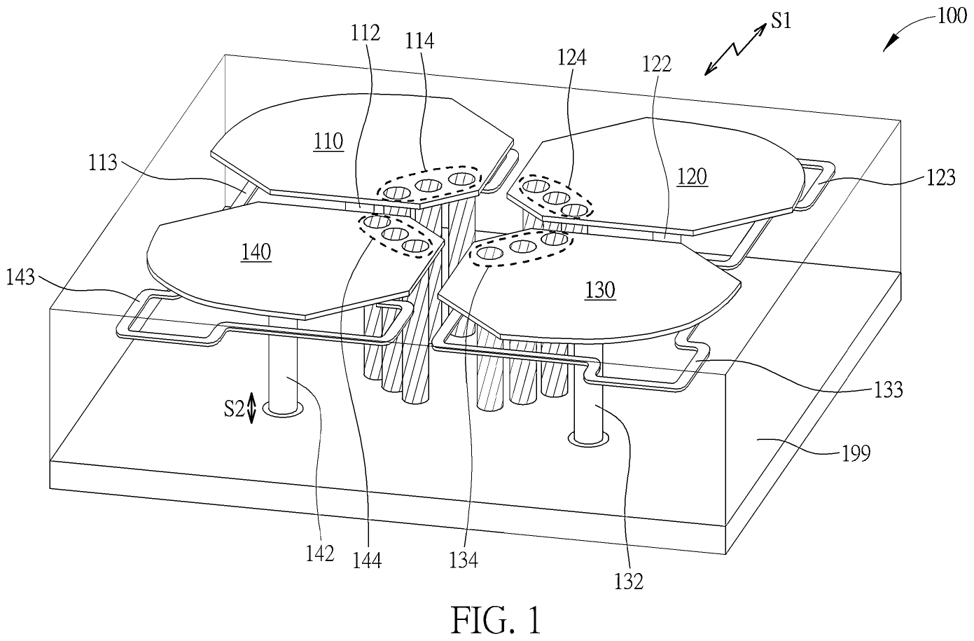

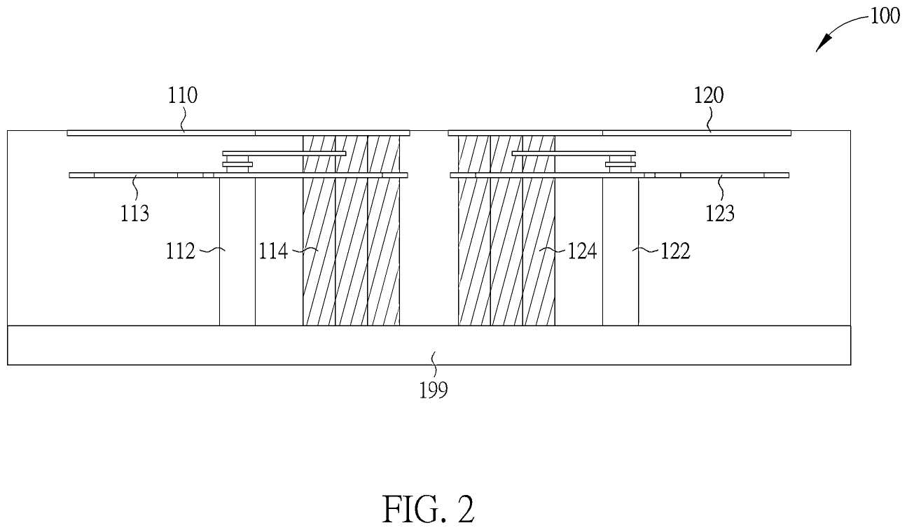

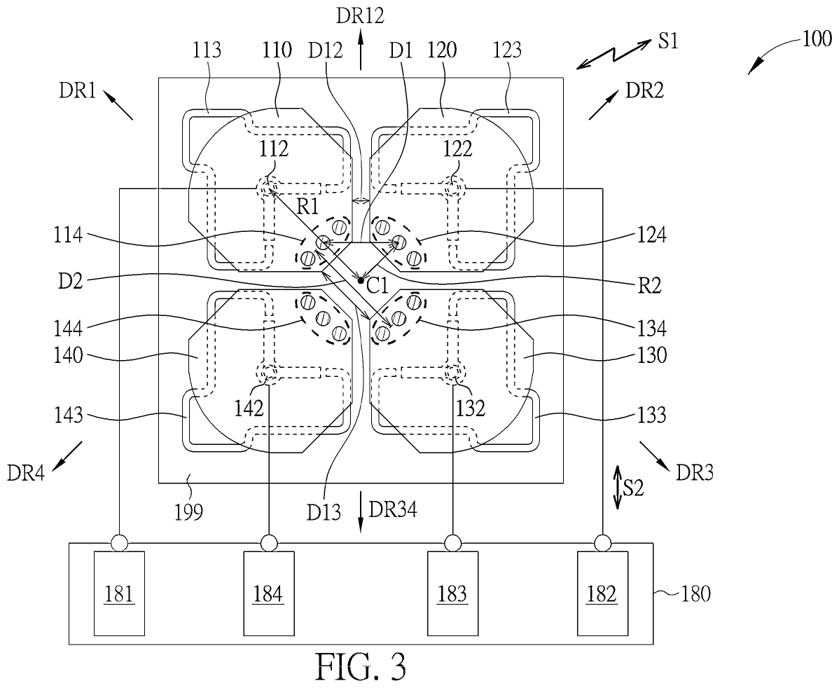

FIG. 1 illustrates an oblique view of an antenna 100 according to an embodiment. FIG. 2 illustrates a side view of the antenna 100 of FIG. 1. FIG. 3 illustrates the antenna 100 connected to a processing circuit 180, where the antenna 100 can be shown in a top view. In FIG. 3, the portions obscured by radiators are depicted with dashed lines.

The antenna 100 can include M radiators and M feeding points. In FIG. 1 to FIG. 3, M equals to four as an example, and the antenna 100 can include four radiators 110, 120, 130 and 140, and four feeding elements 112, 122, 132 and 142.

In FIG. 1 to FIG. 3, M is 4 as an example. According to embodiments, M can be an integer that is greater than 3, such as 4, 6, 8, or any other suitable number. According to embodiments, the number of radiators can be equal to the number of feeding elements. The antenna 100 can be used in a MIMO (multiple input and multiple output) antenna device. If M equals 4, the antenna 100 can be used in a 4×4 MIMO antenna device. If M equals 6, the antenna 100 can be used in a 6×6 MIMO antenna device. If M equals 8, the antenna 100 can be used in an 8×8 MIMO antenna device. The antenna 100 can be utilized in a MIMO antenna device for the simultaneous transmission and reception of multiple data streams, enhancing the data capacity and speed of wireless networks. It is also suitable for high-frequency applications such as Wi-Fi, LTE, 4G, 5G and 6G.

The M radiators 110, 120, 130 and 140 (where M=4 in this example) can wirelessly access a set of first signals S1. The feeding elements 112, 122, 132 and 142 can be formed below the M radiators 110, 120, 130 and 140. The M feeding elements 112, 122, 132 and 142 can be connected to the processing circuit 180. The processing circuit 180 can include a radio-frequency integrated circuit (RFIC). The M feeding elements 112, 122, 132 and 142 can access a set of second signals S2 between the M feeding elements 112, 122, 132 and 142 and the processing circuit 180, where the second signals S2 can be corresponding to the first signals S1. The first signals S1 can be millimeter-wave (mmWave) signals, and can have a frequency greater than 6 GHz.

As shown in FIG. 3, the processing circuit 180 can include M transceivers connected to the M feeding elements respectively. In FIG. 3, M equals to four as an example, and the processing circuit 180 can include four transceivers 181, 182, 183 and 184 connected to the feeding elements 112, 122, 132 and 142 respectively.

Each of the M feeding elements 112, 122, 132 and 142 can be formed below a corresponding radiator of the M radiators 110, 120, 130 and 140. The feeding elements 112 can be formed below the radiator 110 and coupled to the radiator 110. The feeding elements 122 can be formed below the radiator 120 and coupled to the radiator 120. The feeding elements 132 can be formed below the radiator 130 and coupled to the radiator 130. The feeding elements 142 can be formed below the radiator 140 and coupled to the radiator 140. Here, the feeding element and the radiator can be coupled through physical and/or wireless coupling.

The antenna 100 can also include parasitic elements 113, 123, 133 and 143 formed below the radiators 110, 120, 130 and 140 respectively for improving the impedance, bandwidth, and/or gain of the antenna 100.

The antenna 100 can further include M groups of conductive vias. In FIG. 1 to FIG. 3, M is four as an example, and the M groups of conductive vias 114, 124, 134 and 144 can be connected to the radiators 110, 120, 130 and 140 respectively. Each conductive via can connected between a ground plane 199 and a corresponding radiator. The mth groups of conductive via can be connected to the mth radiator correspondingly. The conductive vias can be used for structure support, heat dissipation, and/or other electrical-related requirements. Here, m can be an integer, and 0<m≤M.

According to embodiments, the M feeding elements (e.g., 112, 122, 132 and 142) may not be connected to the ground plane 199. Instead, the M feeding elements (e.g., 112, 122, 132 and 142) can pass through the holes of the ground plane 199 to be connected to the processing circuit 180.

As shown in FIG. 3, the M radiators (e.g., 110, 120, 130, and 140) can be arranged symmetrically around a reference point C1. In the top view, a feeding element (e.g., 112) and the reference point C1 can be separated by a first distance R1. A conductive via of the M groups of conductive vias (e.g., one of the conductive vias 124) and the reference point C1 can be separated by a second distance R2. The first distance R1 can be greater than the second distance R2. Through such an arrangement, interference can be reduced and the effect of exciting the antenna can be improved.

The first signals S1 shown in FIG. 1 to FIG. 3 can have a wavelength (represented as A). According to embodiments, the second distance R2 can be between 0.04 times the wavelength and 0.25 times of wavelength. As shown in FIG. 3, the conductive vias of the first group of conductive vias 114 and the second group of conductive vias 124 can be separated by a distance D1. The conductive vias of the first group of conductive vias 114 and the third group of conductive vias 134 can be separated by a distance D2. According to the embodiments, two vias of different groups of vias can be separated by a distance, and the distance can be between 0.05 times the wavelength and 0.25 times the wavelength, that is, between 0.052 and 0.252. For example, each of the distances D1 and D2 can be between 0.052 and 0.252.

According to embodiments, two of the M radiators (e.g. 110, 120, 130, and 140 in FIG. 3) can be separated by a distance, where the distance can be between 0.001 times the wavelength and 0.25 times the wavelength, that is, between 0.0012 and 0.252. For example, the radiators 110 and 120 can be separated by a distance D12, the radiators 110 and 130 can be separated by a distance D13, and each of the distances D12 and D13 can be between 0.0012 and 0.252.

In FIG. 3, when only radiator 110 is excited and transceiver 181 is used to transmit and receive signals, the radiation pattern can approximately correspond to direction DR1. When only radiator 120 is excited and transceiver 182 is used to transmit and receive signals, the radiation pattern can approximately correspond to direction DR2. When only radiator 130 is excited and transceiver 183 is used to transmit and receive signals, the radiation pattern can approximately correspond to direction DR3. When only radiator 140 is excited and transceiver 184 is used to transmit and receive signals, the radiation pattern can approximately correspond to direction DR4.

For example, in a 4×4 MIMO antenna, the angle between direction DR1 and direction DR2 can be approximately 90 degrees, the angle between direction DR2 and direction DR3 can be approximately 90 degrees, the angle between direction DR3 and direction DR4 can be approximately 90 degrees, and the angle between direction DR4 and direction DR1 can be approximately 90 degrees.

When radiators 110 and 130 are excited and transceivers 181 and 183 are used to transmit and receive signals, the radiation pattern can approximately correspond to a direction out of the paper plane. When radiators 120 and 140 are excited and transceivers 182 and 184 are used to transmit and receive signals, the radiation pattern can approximately correspond to a direction out of the paper plane. When radiators 110 and 120 are excited and transceivers 181 and 182 are used to transmit and receive signals, the radiation pattern can approximately correspond to direction DR12. When radiators 130 and 140 are excited and transceivers 183 and 184 are used to transmit and receive signals, the radiation pattern can approximately correspond to direction DR34.

The above-mentioned excited radiator(s) and the corresponding directions of the radiation pattern are examples to describe that the antenna 100 can support multiple radiation directions for various applications, but embodiments are not limited thereto. By adjusting the number and arrangement of radiators, and adjusting various combinations of excited radiators, the characteristics of the radiation pattern can be effectively adjusted.

In FIG. 3, the position of the processing circuit 180 is not a precise position; it merely indicates that the feeding elements can be connected to the processing circuit 180. In FIG. 3, the directions corresponding to the radiation patterns DR1, DR2, DR3, DR4, DR12, and DR34 can be the directions determined when viewing the antenna from the top view. The directions corresponding to the radiation patterns can be determined by the arrangements of the radiators.

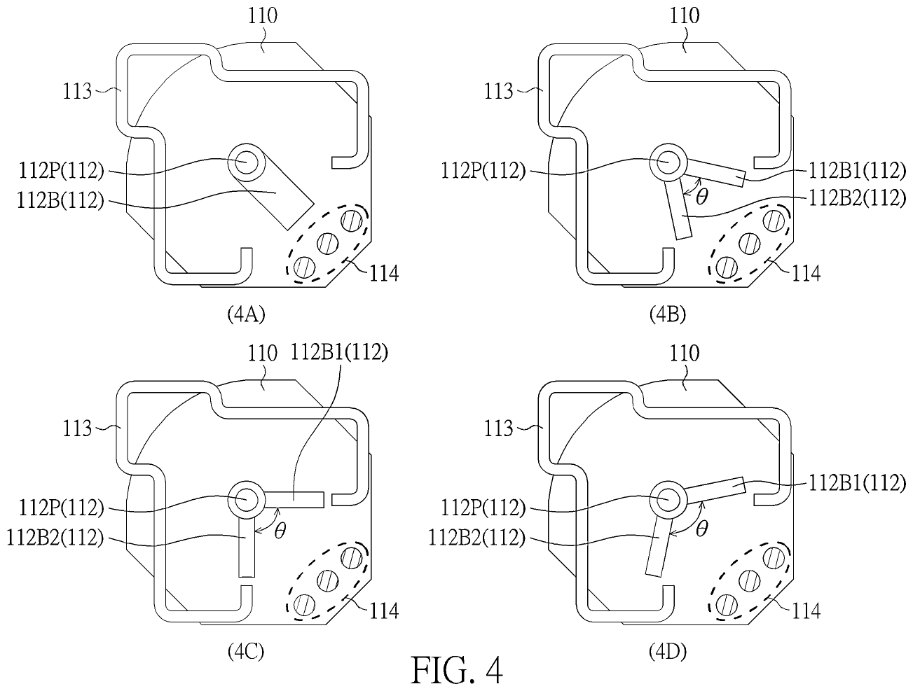

FIG. 4 shows a part of the antenna 100 according to embodiments. FIG. 4 shows four types of feeding elements according to four embodiments. According to embodiments, each feeding element of the M feeding elements in an antenna can include a pillar and at least one bar that is nonparallel to the pillar. The radiator in each of FIGS. 4A) to (4D) in FIG. 4 can be one of the radiators in FIG. 1. In each of FIGS. 4A) to (4D), a radiator and underlying feeding element and parasitic element are shown in a top view, where the parts of the feeding element and parasitic element that are obscured are also shown for explanation.

In FIGS. 4A) to (4D), the feeding element 112 from FIG. 1 can be used as examples. In FIG. 4A), the feeding element 112 can include a pillar 112P and a bar 112B. The pillar 112P can be formed directly beneath the radiator 110, and include a first terminal and a second terminal, where the first terminal of the pillar 112P can be closer to the radiator 110 than the second terminal of the pillar 112P. The bar 112B can be nonparallel to the pillar 112P. For example, the bar 112B can be perpendicular to the pillar 112P. The bar 112B can include a first terminal and a second terminal, where the first terminal of the bar 112B can be connected to the first terminal of the pillar 112P.

In FIGS. 4B), (4C) and (4D), the feeding element 112 can include a pillar 112P and two bars 112B1 and 112B2. The bars 112B1 and 112B2 can be nonparallel to the pillar 112P. For example, the bars 112B1 and 112B2 can be perpendicular to the pillar 112P. Similar to the bar 110B in FIG. 4A), each of the bars 112B1 and 112B2 can include a first terminal and a second terminal, where the first terminal of the bar can be connected to the first terminal of the pillar 112P. In FIGS. 4B), (4C) and (4D), the bars 112B1 and 112B2 can form an angle θ larger than zero degree.

In FIG. 4B), the angle θ can be an acute angle between 0 to 90 degrees. In FIG. 4C), the angle θ can be a right angle that is 90 degrees. In FIG. 4D), the angle θ can be an obtuse angle ranging from 90 to 180 degrees.

As shown in FIG. 4C), the bars 112B1 and 112B2 can optionally point to two terminals of the corresponding parasitic element 113. The aforementioned angle θ can be modified to adjust impedance, bandwidth and/or gain of the antenna 100.

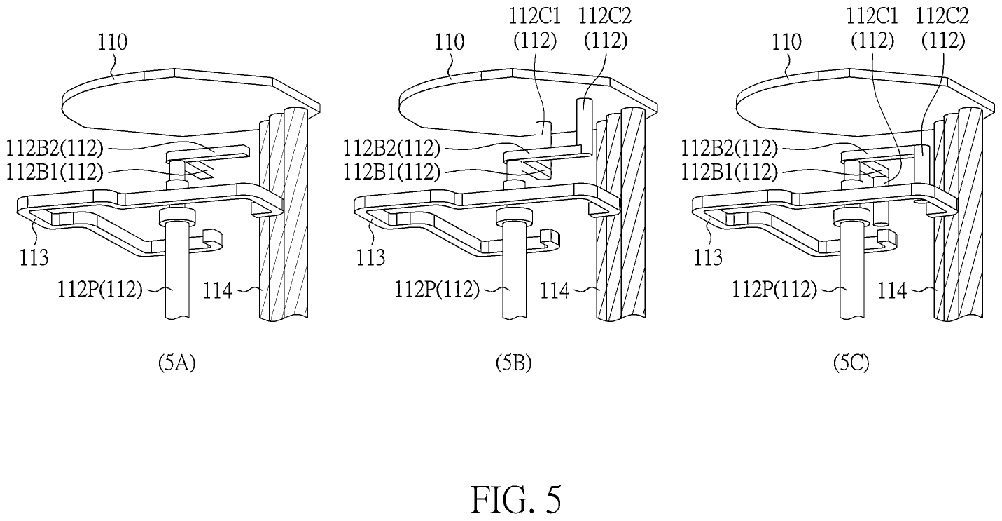

FIG. 5 shows a part of the antenna 100 according to embodiments. FIG. 5 shows three types of feeding elements according to embodiments. In FIG. 5, the radiator 110, the corresponding feeding element 112 and parasitic element 113 are used as examples. In FIGS. 5A), (5B) and (5C), the feeding element 112 can include the pillar 112P and the two bars 112B1 and 112B2. In FIGS. 5B) and (5C), the feeding element 112 can further include a set of connectors, such as connectors 112C1 and 112C2. The connectors 112C1 and 112C2 can be nonparallel to the bars 112B1 and 112B2. The connectors 112C1 and 112C2 can be perpendicular to the bars 112B1 and 112B2.

Each connector of the feeding element can include a first terminal and a second terminal, where the first terminal can be connected to the corresponding bar. In FIG. 5B), the second terminal of the connectors 112C1 and 112C2 can be connected to the radiator 110. In FIG. 5C), the connectors 112C1 and 112C2 can extend downward so that the second terminals of the connectors are not connected to the radiator.

As shown in FIGS. 5A) to (5C), the bars of the feeding element (e.g., 112B1, 112B2) can be formed on a conductive layer between the corresponding radiator and parasitic element. For example, the radiator 110 can be formed on a first conductive layer, the bars 112B1 and 112B2 can be formed on a second conductive layer, the parasitic element 113 can be formed on a third conductive layer, where the second conductive layer can be formed between the first conductive layer and the third conductive layer.

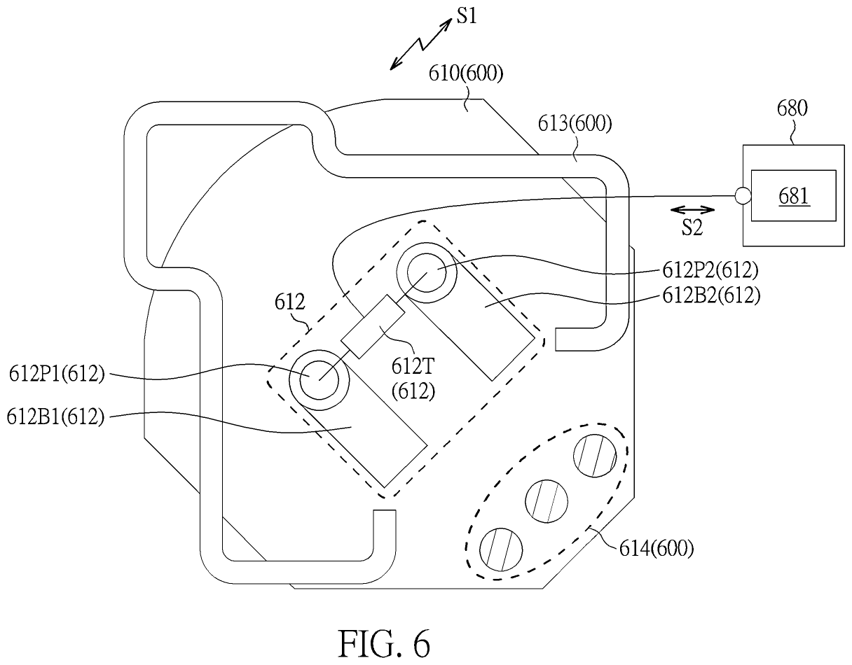

FIG. 6 illustrates a part of an antenna 600 connected to a processing circuit 680 according to an embodiment. In FIG. 6, a radiator 610, a feeding element 612, and a parasitic element 613 of the antenna 600 are shown in a top view. The feeding element 612 and a part of the parasitic element 613 are covered by the radiator 610, but are still shown for explanation. In contrast to the feeding elements in FIG. 1 to FIG. 5, the feeding element 612 can include two pillars and corresponding bars. The feeding element 612 can include pillars 612P1 and 612P2, bars 612B1 and 612B2, and a combiner 612T. Each of the pillars 612P1 and 612P2 can include a first terminal and a second terminal, where the first terminal is closer to the radiator 610. Each of the bars 612B1 and 612B2 can include a first terminal and a second terminal, and first terminals of the bars 612B1 and 612B2 can be connected to the first terminals of the pillars 612P1 and 612P2 respectively. The combiner 612T can include a first terminal, a second terminal and a third terminal, where the first terminal can be connected to the pillar 612P1, a second terminal connected to the second pillar 612P2, and a third terminal connected to a transceiver 681 of the processing circuit 680. The combiner 612T can be a T-junction combiner. In addition, the antenna 600 can include a parasitic element 613 and a group of conductive vias 614. The parasitic element 613 can improve the performance of the antenna, and the conductive vias 614 can be used for structure support, heat dissipation, and/or other electrical-related requirements.

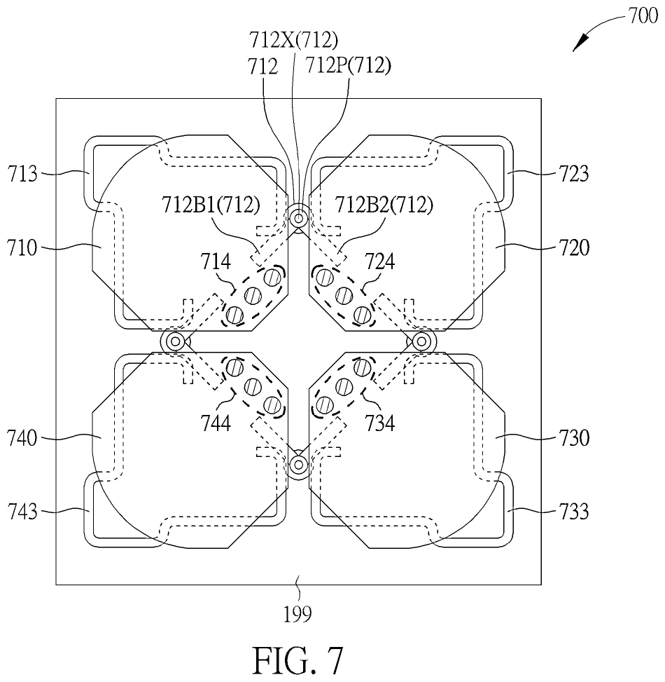

FIG. 7 illustrates an antenna 700 according to another embodiment. FIG. 7 shows a top view of the antenna 700. Differing from FIG. 1 to FIG. 6, in FIG. 7, a pillar of a feeding element may not be formed directly beneath a radiator. Like FIG. 1, the antenna 700 can include M radiators 710, 720, 730 and 740, and M feeding elements 712, 722, 730 and 742, where M equals four as an example in FIG. 7. However, in FIG. 7, each feeding element can include a pillar with an axis between two corresponding radiators, where the pillar may not be formed directly beneath a single radiator.

Here, the feeding element 712 is used as an example for explanation. The feeding element 712 can include a pillar 712P, a first bar 712B1 and a second bar 712B2. The pillar 712P can include a first terminal and a second terminal, where the first terminal can be closer to the radiator. The pillar 712P can have an axis 712X, and the axis 712X can be between two adjacent radiators 710 and 720 in the top view. The first bar 712B1 can be nonparallel to the pillar 712P and connected to the first terminal of the pillar 712P. The second bar 712B2 can be nonparallel to the pillar 712P and connected to the first terminal of the pillar 712P. As shown in FIG. 7, at least a part of the first bar 712B1 can be covered by the radiators 710, and at least a part of the second bar 712B2 can be covered by the radiator720. The antenna 700 can further include parasitic elements 713, 723, 733 and 743 formed below the radiators 710, 720, 730 and 740 respectively. The antenna 700 can further include M groups of conductive vias 714, 724, 734 and 744 connected to the radiators 710, 720, 730 and 740 respectively.

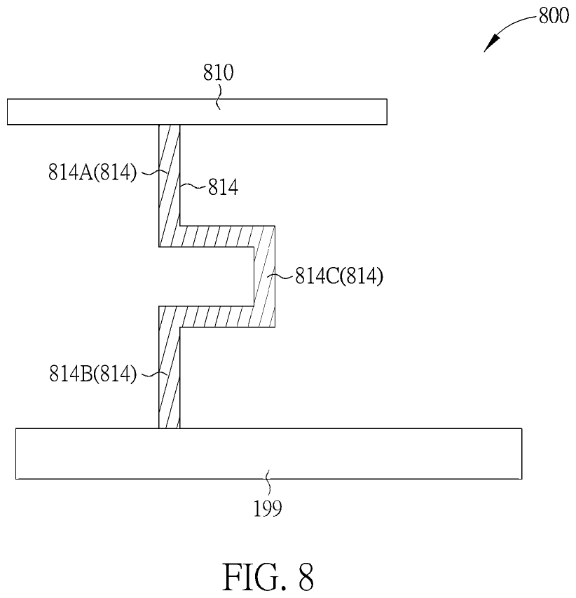

FIG. 8 illustrates a part of an antenna 800 according to another embodiment. FIG. 8 shows a side view of the antenna 800. Similar to the aforementioned antennas, the antenna 800 can include M radiators and corresponding M groups of conductive vias. In FIG. 8, a first radiator 810 and a conductive via 814 are shown as an example for explanation. In FIG. 8, the feeding elements and the parasitic elements are not shown. However, in practice, the antenna 800can include feeding elements and parasitic elements. As shown in FIG. 8, the conductive via 814 can include a first part 814A, a second part 814B and a third part 814C. The first part 814A can be perpendicular to the radiator 810 and connected to the radiator 810. The second part 814B can be perpendicular to the radiator 810 and connected to the ground plane 199. The third part 814C can have a non-linear or curved shape and include a first terminal and a second terminal, where the first terminal can be connected to the first part 814A, and the second terminal can be connected to the second part 814B. By using the conductive via as shown in FIG. 8, the thickness and size of the antenna can be adjusted, thereby further miniaturizing the antenna.

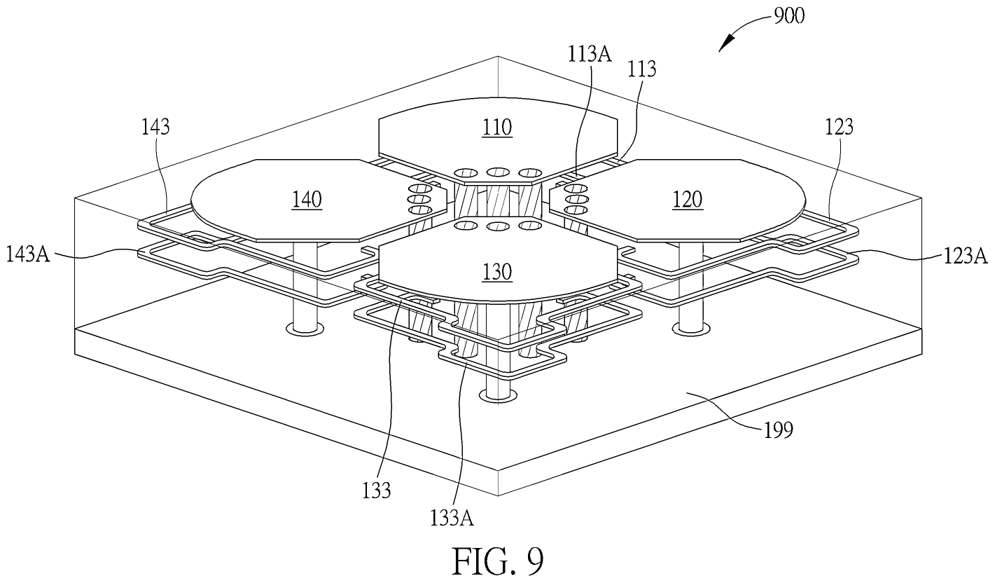

FIG. 9 illustrates an antenna 900 according to another embodiment. FIG. 9 can shown an oblique view of the antenna 900. The similarities between the antenna 900 and the antenna 100 are not reiterated. In FIG. 9, the feeding elements are not shown for simplification. Compared to the antenna 100, two parasitic elements can be formed corresponding to each radiator of the antenna 900. In FIG. 9, in addition to the parasitic elements 113, 123, 133, and 143, the antenna 900 can also include parasitic elements 113A, 123A, 133A, and 143A corresponding to the radiators 110, 120, 130, and 140 respectively. By using two or more parasitic elements for an radiator, the performance of the antenna can be further adjusted.

In FIG. 9, multiple parasitic elements corresponding to the same radiator are formed on different conductive layers. For example, in FIG. 9, the parasitic element 113 can be formed above the parasitic element 113A, but embodiments are not limited thereto. According to other embodiments, a plurality of parasitic elements corresponding to the same radiator can be formed on the same conductive layer. For example, the projection areas of the plurality of parasitic elements corresponding to the same radiator can partially overlap, not overlap, or one can be located within the other.

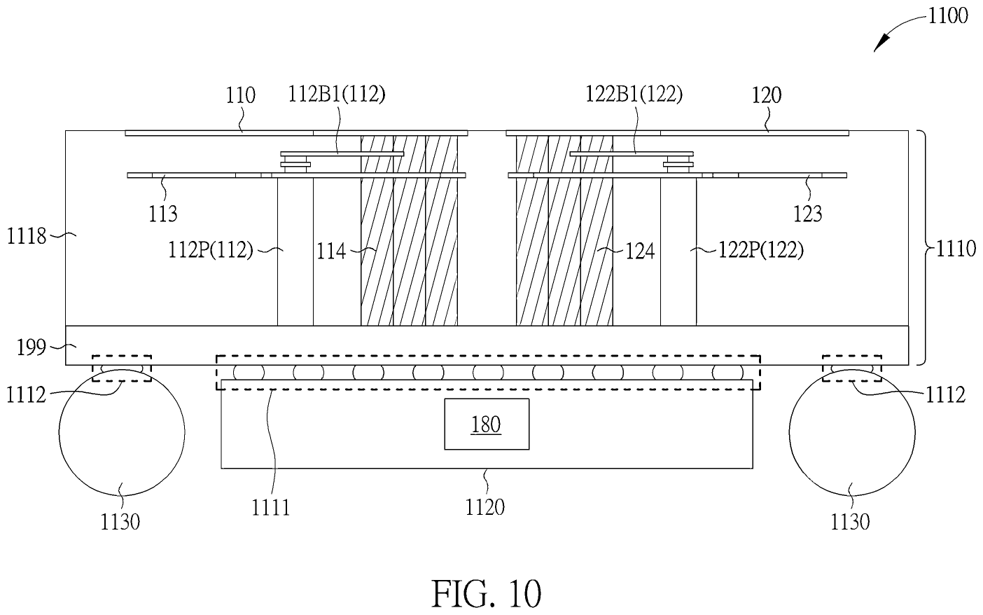

FIG. 10 shows an antenna 1100 according to another embodiment. FIG. 10 can be a side view of the antenna 1100. The antenna 1100 can be similar to antenna 100 but further includes packaging-related structures. The similarities between antenna 1100 and antenna 100 are not reiterated. The antenna 1100 can include a circuit board 1110, an integrated circuit 1120, and a plurality of bonding structures 1130. The circuit board 1110 can be a printed circuit board (PCB) or other suitable circuit board. The circuit board 1110 can include a plurality of first bonding interfaces 1111, a plurality of second bonding interfaces 1112, and a plurality of conductive layers used to form the M radiators and the M feeding elements of the antenna 1100. For example, the radiators 110 and 120, the feeding elements 112 and 122, the parasitic elements 113 and 123, and the conductive vias 114 and 124 can be formed using the conductive layers of the circuit board 1110, and the dielectric layer 1118 of the circuit board 1110 can be formed for insulation and structural support.

The first bonding interfaces 1111 and the second bonding interfaces 1112 can include conductive interfaces, such as metal pads, metal fingers, solder balls, and/or other suitable interfaces. The integrated circuit 1120 can include the abovementioned processing circuit 180 and be connected to the circuit board 1110 through the first bonding interfaces 1111. The bonding structures 1130 can be connected to the circuit board 1110 through the second bonding interfaces 1112. In FIG. 10, the bonding structures 1130 can be solder balls, but this is an example, and the bonding structures 1130 can have another type of structure. The bonding structures 1130 can be soldered to an electronic device, so that the antenna 1100 can be integrated into the electronic device.

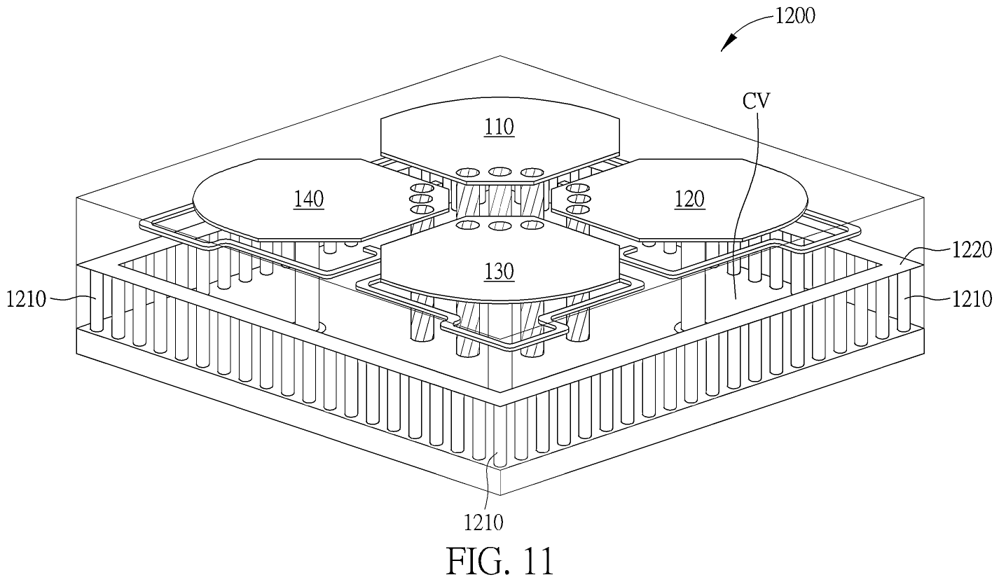

FIG. 11 illustrates an antenna 1200 according to another embodiment. FIG. 11 shows an oblique view of the antenna 1200. The similarities between the antenna 1200 and the aforementioned antennas are not reiterated. The antenna 1200 can include a plurality of conductive vertical elements 1210 to form a cavity CV, where the radiators, the feeding elements, the parasitic elements, and the conductive vias of antenna 1200 can be formed in the cavity CV. In FIG. 11, the conductive vertical elements 1210 can have a columnar structure, which can be formed using conductive structures of a circuit board (e.g., PCB). A conductive ring 1220 can be formed atop and connected to the conductive vertical elements 1210. In FIG. 11, the conductive structures (e.g., 1210 and 1220) used to form the cavity CV can improve the performance and reliability of the antenna 1200.

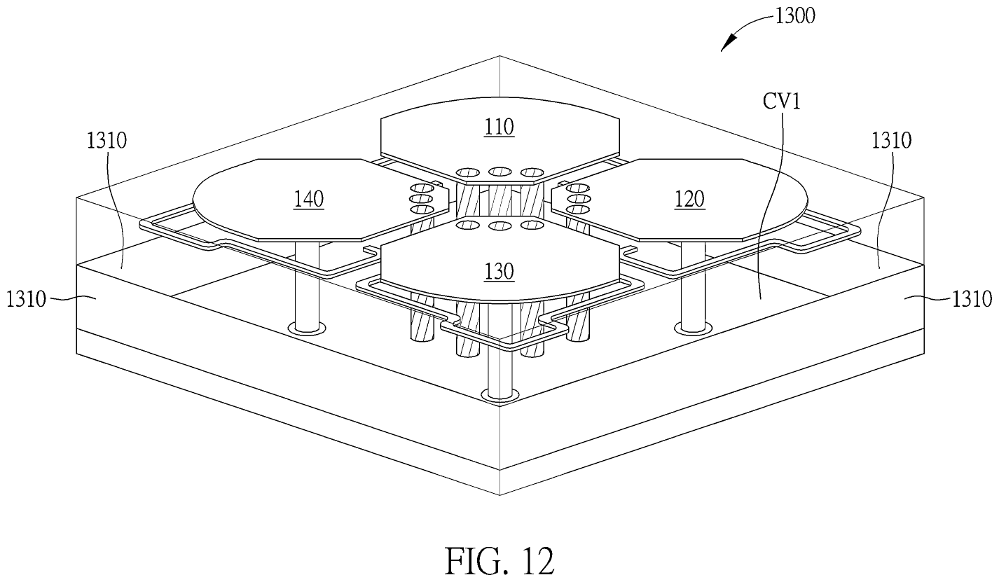

FIG. 12 illustrates an antenna 1300 according to another embodiment. The similarities between the antenna 1300 and the aforementioned antennas are not reiterated. The antenna 1300 can include a plurality of conductive vertical elements 1310 to form a cavity CV1, where the radiators, the feeding elements, the parasitic elements, and the conductive vias of the antenna 1300 can be formed in the cavity CV1. In FIG. 12, the conductive vertical elements 1210 can have a plurality of wall-shaped structures and be formed by coating or sputtering processes.

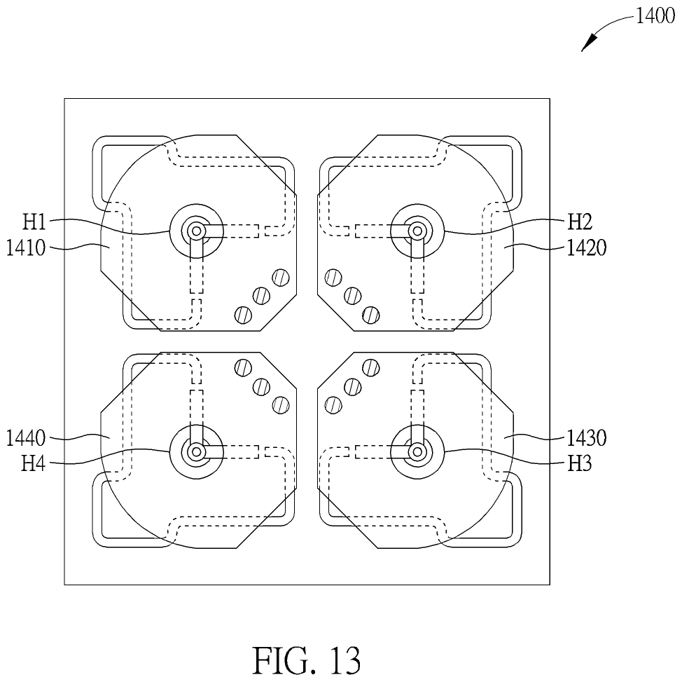

FIG. 13 illustrates an antenna 1400 according to another embodiment. FIG. 13 shows a top view of the antenna 1400. The similarities between the antenna 1400 and the aforementioned antennas are not reiterated. The antenna 1400 can include M radiators, such as radiators 1410, 1420, 1430, and 1440. In the antenna 1400, at least one radiator can have a slot at a non-edge location and/or a notch on an edge to adjust the performance radiating electromagnetic signals. For example, the radiators 1410, 1420, 1430, and 1440 can respectively have slots H1, H2, H3, and H4 to adjust the performance radiating electromagnetic signals.

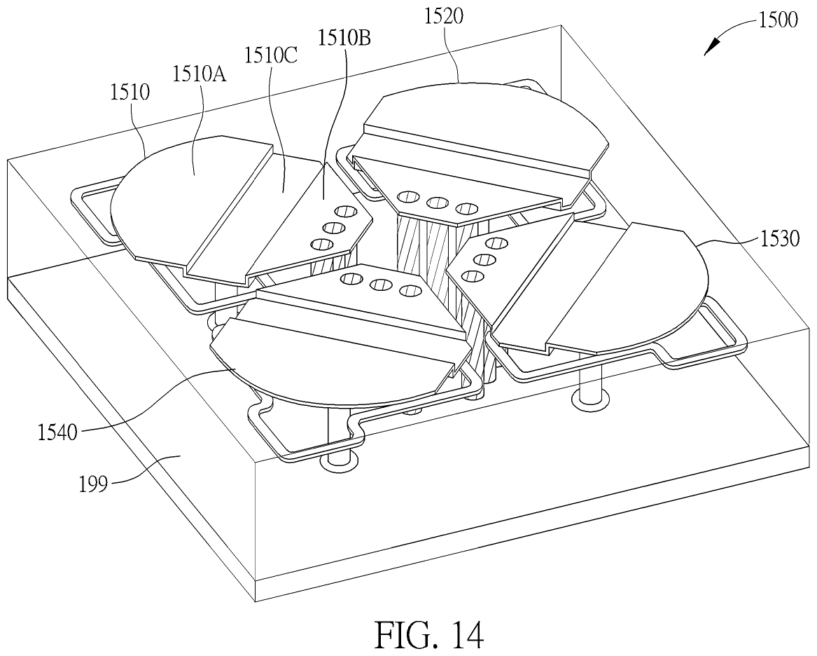

FIG. 14 illustrates an antenna 1500 according to another embodiment. The similarities between the antenna 1500 and the aforementioned antennas are not be reiterated. The antenna 1500 can include M radiators (e.g., 1510, 1520, 1530, and 1540 in FIG. 14). At least one radiator of the antenna 1500 can have a non-planar shape. For example, the radiator 1510 can have a first part 1510A, a second part 1510B, and a third part 1510C. The third part 1510C can be formed below the first part 1510A and the second part 1510B, and connected to the first part 1510A and the second part 1510B. The third part 1510C can be corresponding to a recess. By adjusting the shape of the radiator, the performance of radiating wireless signals can be adjusted, and the size of the antenna can be improved.

By utilizing antennas provided in the embodiments, the performance of the antennas is effectively enhanced, offering more diverse radiation directions (for instance, 2 to 5 radiation directions can be provided), and the antennas can be employed to adjust the radiation pattern. The antennas can possess higher reliability and an improved cumulative distribution function (CDF). The size of the antennas can also be minimized. After actual testing, the antennas can be used for communications of dual broad-band (dual resonances per band). The antennas can support signal frequencies above 6 GHz. The embodiments also provide solutions to integrate antennas into electronic devices (e.g., mobile phones, tablets, laptops).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna comprising:
M radiators configured to wirelessly access a set of first signals; and
M feeding elements formed below the M radiators, connected to a processing circuit, and configured to access a set of second signals corresponding to the set of first signals between the M feeding elements and the processing circuit; and
M is a positive integer larger than 3.

2. The antenna of claim 1, wherein an mth feeding element of the M feeding elements comprises:
a pillar formed beneath an mth radiator of the M radiators, and comprising a first terminal and a second terminal, wherein the first terminal of the pillar is closer to the mth radiator than the second terminal of the pillar;
at least one bar nonparallel to the pillar, each bar comprising a first terminal connected to the first terminal of the pillar, and a second terminal;
wherein m is an integer, and 0<m≤M.

3. The antenna of claim 2, wherein the at least one bar comprises two bars forming an angle larger than zero degree.

4. The antenna of claim 3, wherein the angle is a right angle.

5. The antenna of claim 1, wherein an mth feeding element of the M feeding elements comprises:
a pillar formed beneath an mth radiator of the M radiators and comprising a first terminal and a second terminal, wherein the first terminal of the pillar is closer to the mth radiator than the second terminal of the pillar;
at least one bar nonparallel to the pillar, each bar comprising a first terminal connected to the first terminal of the pillar, and a second terminal;
at least one connector nonparallel to the at least one bar, and each connector comprising a first terminal, and a second terminal connected to a second terminal of a corresponding bar of the at least one bar;
wherein m is an integer, and 0<m≤M.

6. The antenna of claim 1, wherein an mth feeding element of the M feeding elements comprises:
a pillar formed beneath an mth radiator of the M radiators and comprising a first terminal and a second terminal, wherein the first terminal of the pillar is closer to the mth radiator than the second terminal of the pillar;
at least one bar nonparallel to the pillar, each bar comprising a first terminal connected to the first terminal of the pillar, and a second terminal; and
at least one connector nonparallel to the at least one bar, each connector comprising a first terminal connected to the mth radiator of the M radiators, and a second terminal connected to a second terminal of a corresponding bar of the at least one bar;
wherein m is an integer, and 0<m≤M.

7. The antenna of claim 1, wherein an mth feeding element of the M feeding elements comprises:
a first pillar formed beneath an mth radiator of the M radiators, and comprising a first terminal and a second terminal, wherein the first terminal of the first pillar is closer to the corresponding radiator than the second terminal of the first pillar;
a first bar formed beneath the mth radiator of the M radiators, and comprising a first terminal connected to the first terminal of the first pillar, and a second terminal;
a second pillar formed beneath the corresponding radiator of the M radiators, and comprising a first terminal and a second terminal, wherein the first terminal of the second pillar is closer to the corresponding radiator than the second terminal of the second pillar;
a second bar formed beneath the mth radiator of the M radiators, and comprising a first terminal connected to the first terminal of the second pillar, and a second terminal;
a combiner comprising a first terminal connected to the first pillar, a second terminal connected to the second pillar, and a third terminal connected to the processing circuit; and
wherein m is an integer, and 0<m≤M.

8. The antenna of claim 1, wherein each feeding elements of the M feeding elements comprises:
a pillar having an axis located between two corresponding radiators of the M radiators, and comprising a first terminal and a second terminal;
a first bar nonparallel to the pillar and connected to the first terminal of the pillar; and
a second bar nonparallel to the pillar and connected to the first terminal of the pillar.

9. The antenna of claim 1, further comprising:
a ground plane formed below the M radiators; and
M groups of conductive vias, wherein an mth group of conductive vias is configured to support an mth radiator of the M radiators, and each conductive via of the mth group of conductive vias comprises a first terminal connected to the mth radiator and a second terminal connected to the ground plane;
wherein m is an integer, and 0<m≤M.

10. The antenna of claim 9, wherein at least one conductive via of the mth group of conductive vias comprises:
a first part perpendicular to the mth radiator;
a second part perpendicular to the mth radiator; and
a third part having a non-linear shape and comprising a first terminal connected to the first part, and a second terminal connected to the second part.

11. The antenna of claim 9, wherein:
the M radiators are arranged around a reference point;
a feeding element of the M feeding element and the reference point are separated by a first distance;
a conductive via of the M groups of conductive vias and the reference point are separated by a second distance; and
the first distance is greater than the second distance.

12. The antenna of claim 9, wherein:
the set of first signals have a wavelength;
the M radiators are arranged around a reference point;
a conductive via of the M groups of conductive vias and the reference point are separated by a distance; and
the distance is between 0.04 times the wavelength and 0.25 times the wavelength.

13. The antenna of claim 9, wherein:
the set of first signals have a wavelength;
a first conductive via of a first group of conductive vias corresponding to a first radiator of the M radiators is separated from a second conductive via of a second group of conductive vias corresponding to a second radiator of the M radiators by a distance; and
the distance is between 0.05 times the wavelength and 0.25 times the wavelength.

14. The antenna of claim 1, wherein:
the set of first signals have a wavelength;
two of the M radiators are separated by a distance; and
the distance is between 0.001 times the wavelength and 0.25 times the wavelength.

15. The antenna of claim 1, wherein:
an mth feeding element of the M feeding elements comprises:
a pillar formed below an mth radiator of the M radiators and comprising a first terminal and a second terminal, wherein the first terminal of the pillar is closer to the corresponding radiator than the second terminal of the pillar; and
at least one bar each comprising a first terminal connected to the first terminal of the pillar, and a second terminal; and
the antenna further comprises M first parasitic elements;
an mth first parasitic element of the M first parasitic elements is formed below an mth radiator of the M radiators, at least partially covered by the mth radiator of the M radiators, and insulated from the M radiators;
the at least one bar is formed between the M parasitic elements and the M radiators; and
m is an integer, and 0<m≤M.

16. The antenna of claim 14, further comprising:
M second parasitic elements;
wherein an mth second parasitic element of the M second parasitic elements is formed below the mth radiator of the M radiators, at least partially covered by the mth radiator of the M radiators, insulated from the M radiators, and the mth first parasitic element and the mth second parasitic element are formed on a same conductive layer or on different conductive layers; and
m is an integer, and 0<m≤M.

17. The antenna of claim 1, further comprising:
a circuit board comprising a plurality of first bonding interfaces, a plurality of second bonding interfaces, and a plurality of conductive layers configured to form the M radiators and the M feeding elements;
an integrated circuit comprising the processing circuit and connected to the circuit board through the plurality of first bonding interfaces of the circuit board; and
a plurality of bonding structures connected to the circuit board through the plurality of second bonding interfaces of the circuit board.

18. The antenna of claim 1, further comprising:
a plurality of conductive vertical elements forming a cavity;
wherein the M radiators and the M feeding elements are formed inside the cavity.

19. The antenna of claim 1, wherein at least one radiator of the M radiators has a slot at a non-edge location, and/or a notch on an edge.

20. The antenna of claim 1, wherein at least one radiator of the M radiators comprises:
a first part;
a second part; and
a third part formed below the first part and the second part and connected to the first part and the second part;
wherein the third part is corresponding to a recess.
